(19) United States
(12) Patent Application Publication
(10) Pub. No.: US 2012/0120019 A1
(43) Pub. Date: May 17, 2012

(54) EXTERNAL INPUT DEVICE FOR ELECTROSTATIC CAPACITANCE-TYPE TOUCH PANEL

(75) Inventors: Jeaboong CHOI, Yongin-si (KR); Jung-Min LEE, Hanam-si (KR); Hyeong Keun KIM, Hwaseong-si (KR)

(73) Assignee: Research & Business Foundation Sungkyunkwan University, Suwon-si (KR)

(21) Appl. No.: 13/296,603

(22) Filed: Nov. 15, 2011

(30) Foreign Application Priority Data
Nov. 17, 2010 (KR) 10-2010-0114286

(51) Int. Cl. G06F 3/045

(52) U.S. Cl. 345/174

(57) ABSTRACT

The present disclosure provide an external input device for an electrostatic capacitance-type touch panel, the external input device comprising at least one input unit; and at least one electrode unit connected to the at least one input unit and provided on an electrostatic capacitance-type touch panel.

### CROSS-REFERENCE TO RELATED APPLICATION

This application claims the benefit of Korean Patent Application No. 10-2010-0114286 filed on Nov. 17, 2010, the entire disclosures of which are incorporated herein by reference.

### FIELD OF THE INVENTION

The present disclosure relates to an external input device for an electrostatic capacitance-type touch panel. The external input device is provided corresponding to a graphic button displayed on the electrostatic capacitance-type touch panel.

### BACKGROUND OF THE INVENTION

As an information-oriented society has been developed, a demand for a device allowing a user to use information ubiquitously and being easy to operate has been increased. Accordingly, a touch screen employing a touch panel has been introduced.

A touch panel (or a touch screen) used in a smart device can be roughly classified into a resistive film type and an electrostatic capacitance-type. A resistive film type touch panel has high resolution and high response speed but is highly susceptible to damage. An electrostatic capacitance-type touch panel has high resolution and high durability, but it has low detectivity and is difficult to be attached.

Low detectivity of the electrostatic capacitance-type touch panel results in inconvenience and inaccuracy in controlling directions during a game or word processing with a smart device. Further, recently, game applications that supply 3D video games to smart devices through internet downloads have been introduced. Therefore, a keypad provided in a smart device or a virtual keypad is not sufficient for playing such games and a demand for a new key input means has been increased. In this regard, various researches have been carried out to find out a method of using, in addition to an input device on a touch panel of the smart device, a separate input device, such as a keypad and a joypad, to be connected to the touch panel.

### BRIEF SUMMARY OF THE INVENTION

The present disclosure provides an external input device for an electrostatic capacitance-type touch panel. The external device can be operated without a power supply and has improved detectivity, resulting in easy control of input signals.

However, subject matters to be provided by the present disclosure are not limited to the above descriptions and other subject matters which have not been mentioned will be understood by those skilled in the art from the following descriptions.

In accordance with an one aspect of the present disclosure, there is provided an external input device for an electrostatic capacitance-type touch panel, the external input device comprising an input unit provided on an electrostatic capacitance-type touch panel.

In accordance with another aspect of the present disclosure, there is provided an external input device of a portable device, the external input device comprising a portable device including an electrostatic capacitance-type touch panel; an electrode unit provided on the electrostatic capacitance-type touch panel; and an input unit connected to the electrode unit.

An external input device for an electrostatic capacitance-type touch panel in accordance with the present disclosure transmits signals to a touch panel by using variation in electrostatic capacitance. Thus, there is no need to provide an additional power supply or a communication module, resulting in simplification of a configuration of the external input device. Further, as compared with a case where a user directly touches a graphic button displayed on the electrostatic capacitance-type touch panel to input signals, input information can be transmitted more accurately by fixing an electrode unit onto the touch panel and controlling an electrostatic signal through an analog input unit connected to the electrode unit. Furthermore, the external input device can be applied to various devices, including smart devices, employing an electrostatic capacitance-type touch panel without any limitation.

### BRIEF DESCRIPTION OF THE DRAWINGS

Non-limiting and non-exhaustive embodiments will be described in conjunction with the accompanying drawings. Understanding that these drawings depict only several embodiments in accordance with the disclosure and are, therefore, not to be intended to limit its scope, the disclosure will be described with specificity and detail through use of the accompanying drawings, in which:

FIG. 1 is a photo showing an experiment of a touch reaction of an electrostatic capacitance-type touch panel using silver foil instead of a human finger in accordance with an embodiment of the present disclosure;

FIG. 2 is an exemplary diagram of an external input device for an electrostatic capacitance-type touch panel in accordance with an embodiment of the present disclosure;

FIGS. 3A to 3D are exemplary diagrams showing various input units in accordance with an embodiment of the present disclosure;

FIGS. 4A to 4C are exemplary diagrams showing an operation principle of an external input device for an electrostatic capacitance-type touch panel in accordance with an embodiment of the present disclosure;

FIG. 5 is an exemplary diagram of an external input device for an electrostatic capacitance-type touch panel in accordance with another embodiment of the present disclosure;

FIG. 6 is an exemplary diagram of an external input device for an electrostatic capacitance-type touch panel in accordance with still another embodiment of the present disclosure;

FIGS. 7A and 7B are exemplary diagrams of a keypad for an electrostatic capacitance-type touch panel in accordance with an embodiment of the present disclosure; and

FIGS. 8A and 8B are exemplary diagrams of an external input device for an electrostatic capacitance-type touch panel on a frame which can be combined with the touch panel in accordance with an embodiment of the present disclosure.

### DETAILED DESCRIPTION OF THE INVENTION

Hereinafter, embodiments and examples of the present disclosure will be described in detail with reference to the accompanying drawings so that the present disclosure may be readily implemented by those skilled in the art.

However, it is to be noted that the present disclosure is not limited to the embodiments but can be realized in various other ways. In the drawings, parts irrelevant to the description are omitted for the simplicity of explanation, and like reference numerals denote like parts through the whole document.

Through the whole document, the term “comprises or includes” and/or “comprising or including” used in the document means that one or more other components, steps, operation and/or existence or addition of elements are not excluded in addition to the described components, steps, operation and/or elements unless context dictates otherwise.

The terms “about or approximately” or “substantially” are intended to have meanings close to numerical values or ranges specified with an allowable error and intended to prevent accurate or absolute numerical values disclosed for understanding of the present disclosure from being illegally or unfairly used by any unconscionable third party.

In accordance with an aspect of the present disclosure, there may be provided an external input device for an electrostatic capacitance-type touch panel. The external input device may include at least one input unit provided on an electrostatic capacitance-type touch panel. In an example, the input unit may include, but is not limited to, a conductive material. By way of example, the input unit may be entirely made of a conductive material or a partially made of a conductive material. Further, the input unit may be positioned on, but not limited to, a graphic displayed at a display unit of the electrostatic capacitance-type touch panel.

In an exemplary embodiment, the external input device for an electrostatic capacitance-type touch panel may further include at least one electrode unit connected to the input unit.

In an exemplary embodiment, the input unit and the electrode unit may be connected to each other through, but not limited to, a conductive wire. In an example, an end of the conductive wire may be provided at, but not limited to, a lower are of the input unit and the other end of the conductive wire may be connected to, but not limited to, the electrode unit.

In an exemplary embodiment, the external input device for an electrostatic capacitance-type touch panel may further include a fixing unit provided below the input unit and configured to fix an end of the conductive wire.

In an example, the input unit may include, but is not limited to, a joystick.

In an exemplary embodiment, input unit may be provided on, but is not limited to, a frame which can be combined with the electrostatic capacitance-type touch panel.

In an example, one input unit may include, but is not limited to, a conductive material.

In an exemplary embodiment, the electrode unit may include, but not limited to, graphene. A material of the electrode unit may include typical materials, such as metal, graphene or ITO, and carbon nanotube, used in the art for an electrode.

In an exemplary embodiment, the input unit and/or the electrode unit may be, but is not limited to, plural in number. In an example, each of the plural input units may be provided corresponding to, but not limited to, each of the plural electrode units.

In an exemplary embodiment, the electrode unit may be, but is not limited to, transparent.

In an exemplary embodiment, the electrode unit corresponds to at least one graphic button displayed on a display unit of the electrostatic capacitance-type touch panel and is provided on, but not limited to, the graphic button. In an example, the graphic button may include, but is not limited to, a number key, a letter key, a symbol key or a direction key.

In an exemplary embodiment, the graphic button may be, but is not limited to, plural in number.

In an example, the graphic button may be provided on, but not limited to, one side of the electrostatic capacitance-type touch panel.

In an exemplary embodiment, the external input device for an electrostatic capacitance-type touch panel may further include, but is not limited to, a signal controller provided between the input unit and the electrode unit and configured to disperse an electrostatic signal generated by the input unit and supply the dispersed signals to the electrode unit.

In another embodiment of the present disclosure, there may be provided an external input device of a portable device. The external input device may include a portable device including an electrostatic capacitance-type touch panel, at least one electrode unit provided on the electrostatic capacitance-type touch panel, and at least one input unit connected to the electrode unit.

In an exemplary embodiment, the electrode unit and the input unit may be connected to each other through, but not limited to, a conductive wire.

Hereinafter, by reference to the accompanying drawings, an external input device for an electrostatic capacitance-type touch panel in accordance with the present disclosure will be explained in detail. However, the present disclosure is not limited to the following descriptions.

An electrostatic capacitance-type touch panel may be operated by detecting micro current flowing to a transparent electrode on a substrate of the touch panel from a human body. Since a film is not used in the electrostatic capacitance-type touch panel, the electrostatic capacitance-type touch panel may have high durability and reliability as compared with a resistive film type touch panel. Further, the electrostatic capacitance-type touch panel may have short reaction time and high transmittance and can recognize multi touch input.

The present disclosure is provided to change electrostatic capacitance within an electrostatic capacitance-type touch panel without a human touch on the touch panel based on a principle that when an electrostatic capacitance-type touch panel is touched by a human body, there is a change in electrostatic capacitance and the electrostatic capacitance-type touch panel is operated by detecting a touched position based on the change.

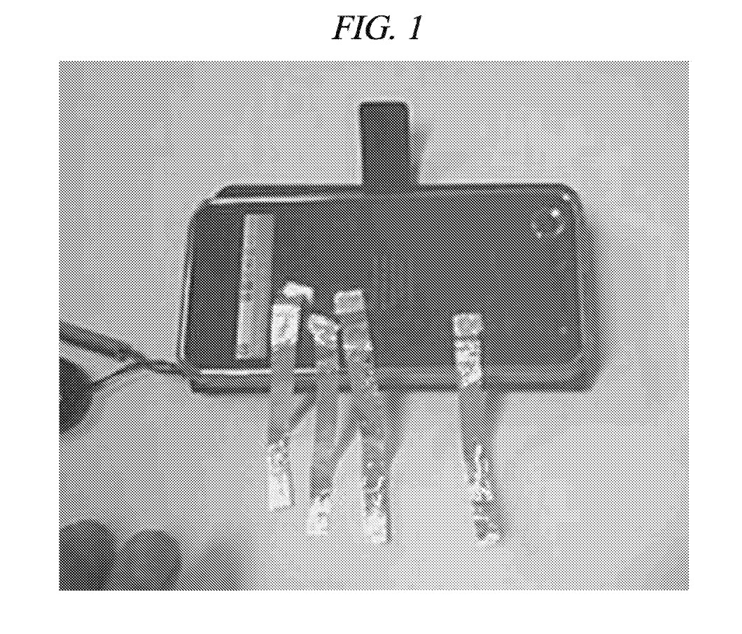

FIG. 1 is a photo showing an experiment of a touch reaction of an electrostatic capacitance-type touch panel using silver foil instead of a human finger in accordance with an embodiment of the present disclosure. As depicted in FIG. 1, it was found that when a side of the silver foil is fixed on the electrostatic capacitance-type touch panel and the other side of the silver foil is touched by a finger, a touch reaction can be made on the touch panel.

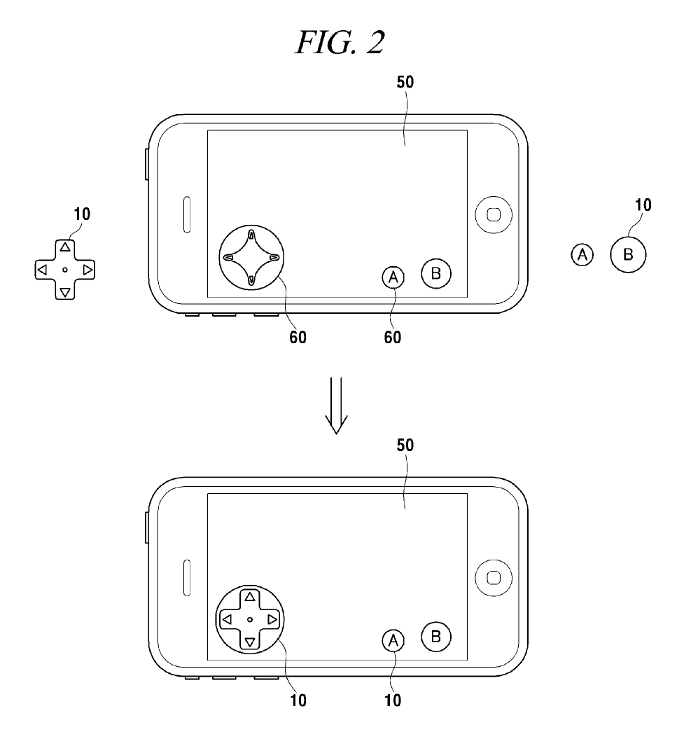

FIG. 2 is an exemplary diagram of an external input device for an electrostatic capacitance-type touch panel in accordance with the present disclosure. The electrostatic capacitance-type touch panel may include an input unit 10 provided on the electrostatic capacitance-type touch panel. As depicted in FIG. 2, if the input unit 10 is directly connected to the touch panel, there may be no need to provide an electrode unit and a conductive wire which are described later. Thus, a configuration of the external input device for the electrostatic capacitance-type touch panel can be simplified. It may be possible to change electrostatic capacitance on the electrostatic capacitance-type touch panel by pressing the input unit 10 provided on the electrostatic capacitance-type touch panel. Thus, it may be possible to achieve an effect equivalent to directly pressing the electrostatic capacitance-type touch panel.

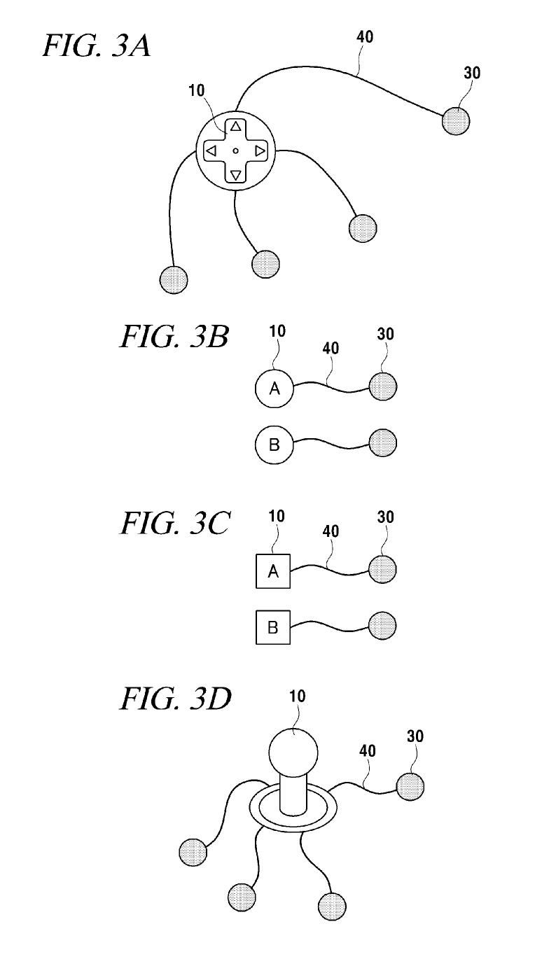

In this case, the input unit 10 may be made of a conductive material or may include a conductive material. By way of example, the input unit 10 may be entirely made of a conductive material or only its lower part facing the touch panel or the conductive wire may be made of a conductive material. That is, if only the lower part of the input unit 10 is made of the conductive material, the input unit can be used without any limitation. The input unit can be formed without any limitation in shape if the shape is typically employed in the art as an input button. By way of example, as depicted in FIG. 3A, the input unit 10 may be formed in, but not limited to, a cross shape or a circular shape (FIG. 3B) or a quadrangular shape (FIG. 3C). The input unit 10 may be formed in, but not limited to, a joystick shape as depicted in FIG. 3D.

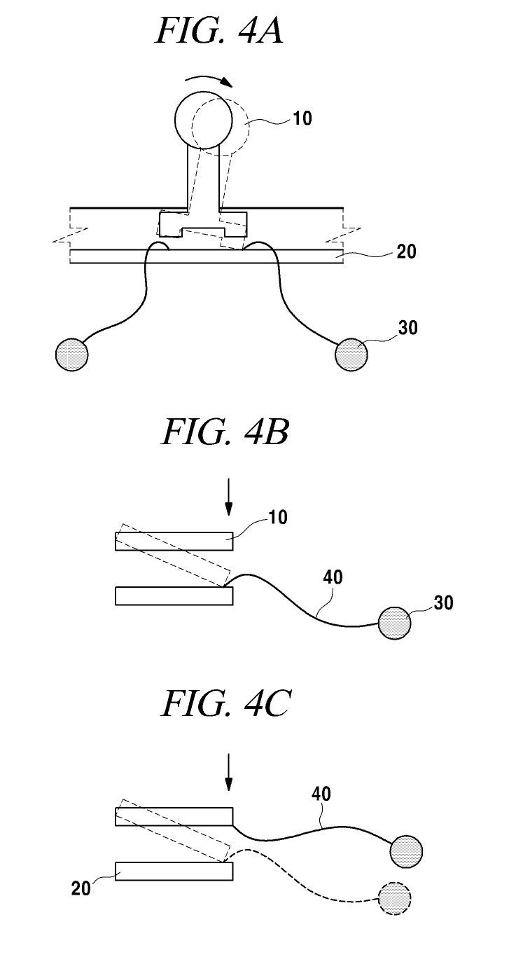

FIGS. 4A to 4C are exemplary diagrams showing an external input device for an electrostatic capacitance-type touch panel in accordance with another embodiment of the present disclosure. Unlike the external input device shown in FIG. 2, an external input device for an electrostatic capacitance-type touch panel may include, in addition to an input unit 10, an electrode unit 30 connected to the input unit 10 through a conductive wire 40 and positioned on the electrostatic capacitance-type touch panel. Referring to FIGS. 4A and 4B, an end of the conductive wire 40 may be fixed to a fixing unit 20 provided below the input unit 10. Otherwise, as depicted in FIG. 4C, the conductive wire 40 may be fixed at a lower side of the input unit 10 unlike the conductive wires 40 depicted in FIGS. 4A and 4B. By way of example, the input unit 10, the conductive wire 40 or the fixing unit 20 can be configured without any limitation if an electrostatic signal generated by pressing the input unit 10 is transmitted to the electrode unit 30 so as to change electrostatic capacitance on a display of the touch panel. Desirably, the input unit 10, the conductive wire 40 or the fixing unit 20 may be configured as a switch as described above.

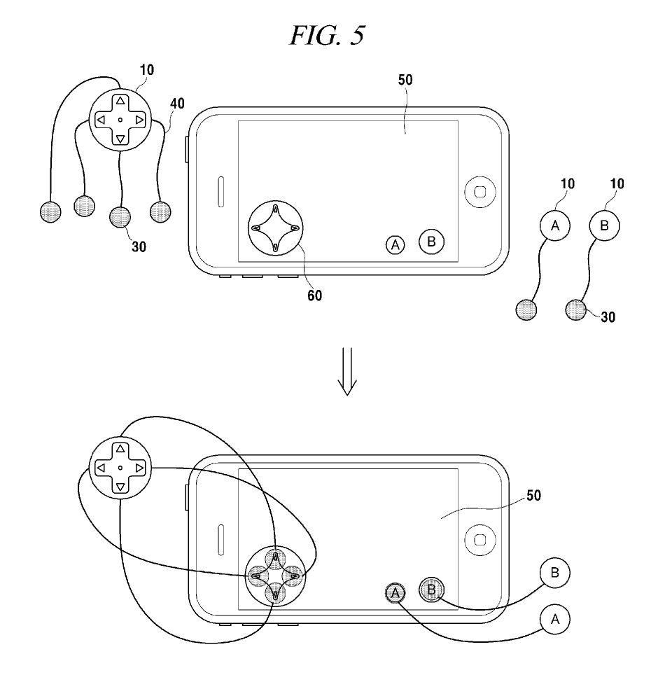

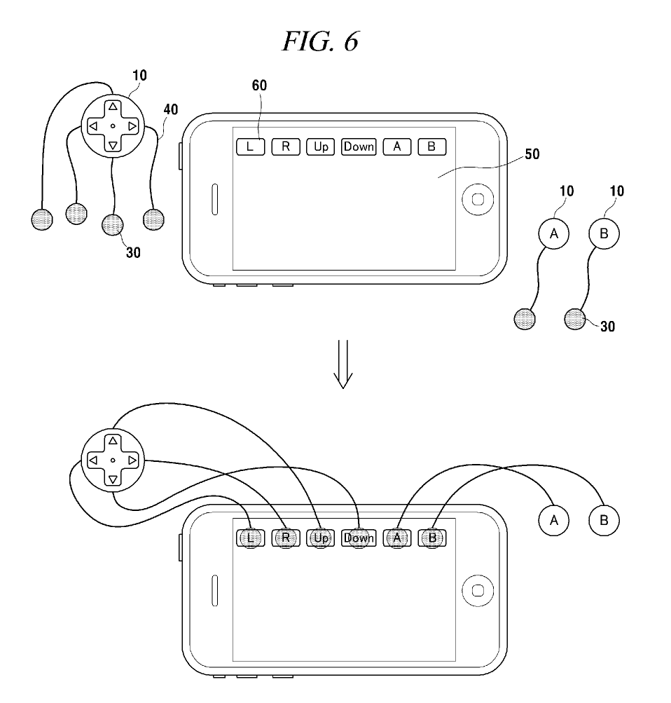

FIG. 5 shows that an electrode unit of an external input device for an electrostatic capacitance-type touch panel in accordance with the present disclosure is positioned on the electrostatic capacitance-type touch panel. The electrode unit can be provided without any limitation in position if it is on the electrostatic capacitance-type touch panel. By way of example, the electrode unit may be positioned at a display unit of the electrostatic capacitance-type touch panel, a front surface of the electrostatic capacitance-type touch panel or a rear surface of the electrostatic capacitance-type touch panel.

As depicted in FIG. 5, the electrode unit 30 may be positioned on a graphic button 60 displayed on a display unit 50 of the touch panel. The graphic button 60 on the touch panel may include, but is not limited to, a number key, a letter key, a symbol key or a direction key. The graphic button 60 may include a button provided to input information and/or signals on the touch panel or operate the touch panel.

The graphic buttons 60 may be positioned at a lower left or an upper left of the display unit as depicted in FIG. 5. Otherwise, the graphic buttons 60 may be positioned on one side of the display unit, for example, on an upper side of the display as depicted in FIG. 5. In this case, a covered area of the touch panel by an electrode provided on the graphic button can be minimized as compared with a case where the graphic buttons 60 are dispersed on the display unit. By way of example, a program or application that enables graphics to be displayed on the touch panel may provide a function of arranging the graphic buttons 60 on a side of the display unit or rearranging the dispersed graphic buttons 60 on a side of the display. Thus, a covered area of the display unit of the touch panel by the electrode provided on the graphic button can be minimized. In order to prevent the electrode provided on the graphic button from covering the display of the touch panel, a transparent electrode can be used as the electrode. By way of example, the electrode may be made of, but not limited to, graphene.

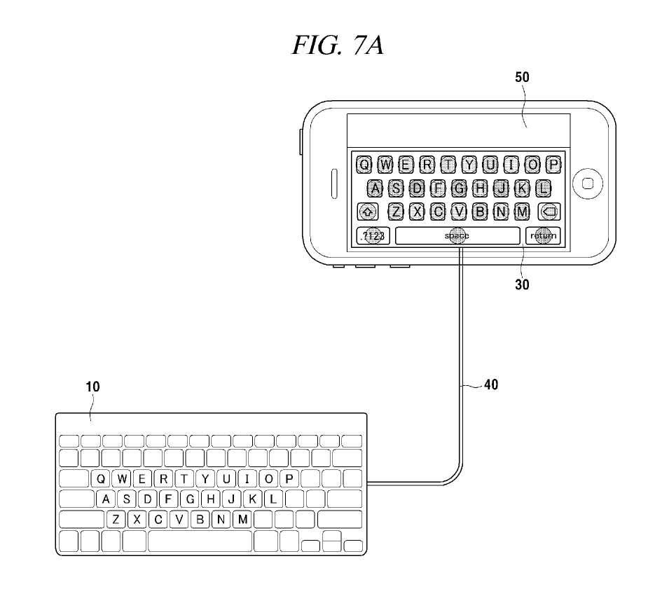

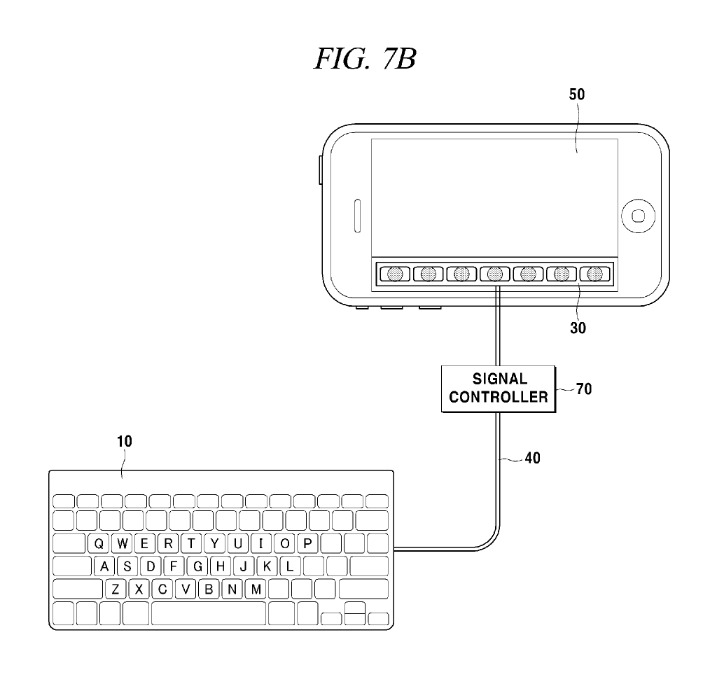

There has been described the input unit 10 corresponding to a graphic button including a simple direction key or a symbol key. However, the input unit 10 may include a keyboard type input unit as depicted in FIGS. 7A and 7B.

Referring to FIG. 7A, the keyboard type input unit 10 may include a plurality of input buttons. The input buttons may be connected to the same number of electrode units, respectively, through conductive wires. A one-to-one connection can be made between the input buttons and the electrode units. By way of example, a first input button displayed as “a” on the input unit 10 may be connected to a first electrode displayed as “a” on the display unit and a second input button displayed as “b” may be connected to a second electrode displayed as “b” on the display unit.

By using a signal controller capable of dispersing electrostatic signals generated by pressing the input unit 10 and a multi touch function of the display, a covered area of the display unit by the electrode unit can be minimized.

By way of example, an electrostatic signal generated by pressing a single input button on the input unit 10 can be dispersed into multiple electrostatic signals through the signal controller. Multiple graphic buttons displayed on the display unit may be touched by the dispersed electrostatic signals. Thus, pressing the single input button can achieve an effect equivalent to pressing the multiple graphic buttons. By way of example, with a program or application capable of assigning multi touch input values of the multiple graphic buttons to input values of input buttons of the input unit 10, input values of all input buttons on the keyboard can be executed by using a lesser number of graphic buttons. Therefore, an area of the electrode unit provided on the graphic buttons can be reduced. By way example, if the signal controller may disperse a single electrostatic signal to three signals and there are seven graphic buttons displayed on the display unit, the number of cases of input values of the graphic buttons caused by the single electrostatic signal may be 210 (7×6×5). That is, with a program or application capable of assigning each of the dispersed signals to each of the input values of the input buttons on the keyboard, all input values of the input buttons on the keyboard can be executed by using a lesser number of graphic buttons. Thus, an area of electrode unit provided on the graphic buttons can be reduced.

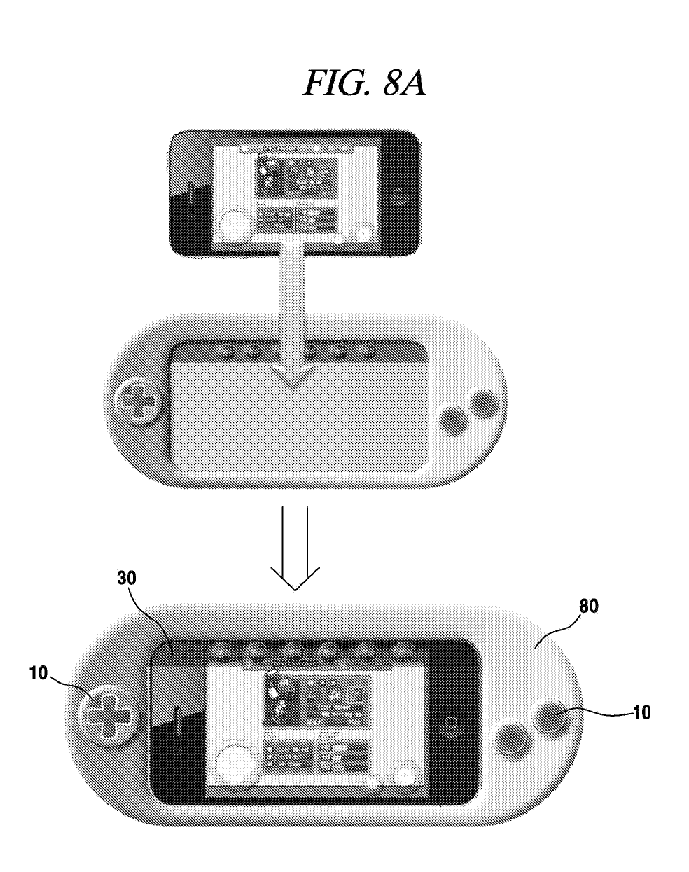

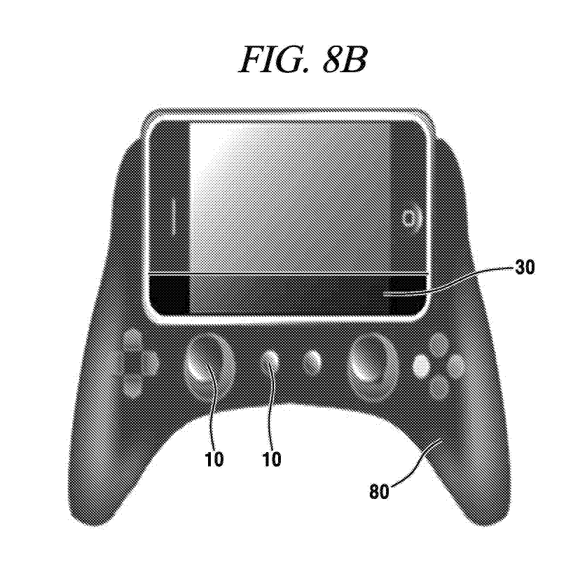

FIGS. 8A and 8B are exemplary diagrams of the input unit 10 in a frame which can be combined with an electrostatic capacitance-type touch panel. The frame in which the input unit 10 is provided may be provided without any limitation in shape if it is combined with and fixed to the electrostatic capacitance-type touch panel as depicted in FIGS. 8A and 8B. A position and/or arrangement of input buttons on the frame are not limited.

The above-described embodiments and examples are provided for the purpose of illustration of the present disclosure but the present disclosure is not limited thereto. It would be understood by those skilled in the art that various changes and modifications may be made without changing technical conception and essential features of the present disclosure.

What is claimed is:

1. An external input device for an electrostatic capacitance-type touch panel, the external input device comprising:
at least one input unit provided on an electrostatic capacitance-type touch panel.

2. The external input device for an electrostatic capacitance-type touch panel of claim 1, further comprising:
at least one electrode unit connected to the at least one input unit and provided on an electrostatic capacitance-type touch panel.

3. The external input device for an electrostatic capacitance-type touch panel of claim 2,
wherein the at least one input unit and the at least one electrode unit are connected to each other through a conductive wire.

4. The external input device for an electrostatic capacitance-type touch panel of claim 3, further comprising:
a fixing unit provided below the input unit and configured to fix an end of the conductive wire.

5. The external input device for an electrostatic capacitance-type touch panel of claim 2,
wherein the at least one input unit includes a conductive material.

6. The external input device for an electrostatic capacitance-type touch panel of claim 2,
wherein the at least one input unit is provided on a frame which is combined with the electrostatic capacitance-type touch panel.

7. The external input device for an electrostatic capacitance-type touch panel of claim 2,
wherein the at least one input unit includes a joystick.

8. The external input device for an electrostatic capacitance-type touch panel of claim 2,
wherein the at least one electrode unit includes graphene.

9. The external input device for an electrostatic capacitance-type touch panel of claim 2,
wherein the at least one input unit and/or the at least one electrode unit is plural in number.

10. The external input device for an electrostatic capacitance-type touch panel of claim 9,
wherein each of the plural input units is provided corresponding to each of the plural electrode units.

11. The external input device for an electrostatic capacitance-type touch panel of claim 2,
wherein the at least one electrode unit is transparent.

12. The external input device for an electrostatic capacitance-type touch panel of claim 2,
wherein the at least one electrode unit corresponds to at least one graphic button displayed on a display unit of the electrostatic capacitance-type touch panel and is provided on the at least one graphic button.

13. The external input device for an electrostatic capacitance-type touch panel of claim 12,
wherein the at least one graphic button includes a number key, a letter key, a symbol key or a direction key.

14. The external input device for an electrostatic capacitance-type touch panel of claim 12,
wherein the at least one graphic button is plural in number.

15. The external input device for an electrostatic capacitance-type touch panel of claim 12,
wherein the at least one graphic button is provided on one side of the electrostatic capacitance-type touch panel.

16. The external input device for an electrostatic capacitance-type touch panel of claim 2, further comprising:
a signal controller provided between the at least one input unit and the at least one electrode unit and configured to disperse an electrostatic signal generated by the at least one input unit and supply the dispersed signals to the at least one electrode unit.

17. An external input device of a portable device comprising:
a portable device including an electrostatic capacitance-type touch panel;
at least one electrode unit provided on the electrostatic capacitance-type touch panel; and
at least one input unit connected to the electrode unit.

18. The external input device for a portable device of claim 17,
wherein the electrode unit and the input unit are connected to each other through a conductive wire.
